(19) United States
(12) Patent Application Publication
(10) Pub. No.: US 2024/0326144 A1
(43) Pub. Date: Oct. 3, 2024

(54) GEAR MACHINING DEVICE

(71) Applicant: KANZAKI KOKYUKOKI MFG. CO., LTD., Amagasaki-shi (JP)

(72) Inventors: Yoichi ONISHI, Amagasaki-shi (JP); Satoru TAKESHITA, Amagasaki-shi (JP); Yasuhiro KUROKAWA, Amagasaki-shi (JP)

(21) Appl. No.: 18/621,192

(22) Filed: Mar. 29, 2024

(30) Foreign Application Priority Data
Mar. 31, 2023 (JP) 2023-059657

(51) Int. Cl. B23F 1/02

(52) U.S. Cl. CPC B23F 1/02

(57) ABSTRACT

[Problem] To provide a gear machining device enabling machining by a plurality of tools with a simple configuration. [Solution] A gear machining device according to the present invention includes: a base; a tool support unit that is disposed on the base, and has internal gear-shaped first and second tools; a workpiece support unit that is disposed on the base, and rotatably supports a gear to be machined; and a control unit that controls driving of the tool support unit and the workpiece support unit, the first tool and the second tool are immovably fixed at an interval in an axial direction of each of the first tool and the second tool; each of the first and second tools machines while meshing with the gear to be machined, the workpiece support unit is relatively movable with respect to the tool support unit in a first direction along an axial direction of the gear to be machined, the workpiece support unit is relatively movable with respect to the gear to be machined in such a second direction as to approach and separate from the first and second tools, the tool support unit is rotatable around a vertical axis extending vertically on the base, and the control unit sets one of the first tool and the second tool as a tool for machining that machines the gear to be machined, and machines the gear to be machined after moving the tool for machining to such a position that the tool for machining meshes with the gear to be machined.

### CROSS REFERENCE TO RELATED APPLICATIONS

The present invention claims priority under 35 U.S.C. § 119 to Japanese Application, 2023-059657, filed on Mar. 31, 2023, the entire contents of which being incorporated herein by reference.

### TECHNICAL FIELD

The present invention relates to a gear machining device, a gear machining method, and a gear machining program.

### BACKGROUND ART

For example, Patent Document 1 describes a gear machining device that performs horning on a tooth surface of a gear to be machined. In this device, an external gear-shaped workpiece that is a gear to be machined is supported by a workpiece support unit composed of a headstock and a tailstock by holding the workpiece from axial both ends, and then an annular tool support unit disposed between the two fixtures and having an internal gear-shaped tool is meshed while maintaining a predetermined intersection angle with respect to the workpiece. Then, by driving the tool support unit and rotating the tool, the workpiece is rotated along with the tool, and finish machining of the workpiece tooth surface is performed. Depending on the type of a gear machining device, some devices also perform finish machining by driving a headstock to rotate both a workpiece and a tool synchronously.

In the above gear machining device, the two tools are installed side by side in the rotation axis direction in a housing of the tool support unit, and when machining, one of the tools is moved to the vicinity of the center in the axial direction of the housing to be meshed with the workpiece, so that machining is performed. The two tools can be used, and therefore, for example, setup time can be shortened, or different types of tools are provided, so that it is possible to machine a plurality of types of workpieces.

### PRIOR ART DOCUMENT

### Patent Document

Patent Document 1: Japanese Patent Application Laid-open No. 7-24634

### SUMMARY OF INVENTION

### Technical Problem

However, in order to mesh one of the tools with the workpiece, a mechanical sliding device that supports the tool support unit having the two tools so as to be movable in one direction or the other direction along the rotation axis direction and moves one of the tools toward the workpiece is attached. Consequently, there is a problem that an overall structure of the gear machining device becomes complicated, and the cost is increased. The present invention has been made to solve the above problem, and an object of the present invention is to provides a gear machining device, a gear machining method, and a gear machining program that have a simple configuration which does not require the sliding device and can perform machining using a plurality of tools.

### Solution to Problem

A gear machining device according to the present invention includes: a base: a tool support unit that is disposed on the base, and has internal gear-shaped rotatable first and second tools: a workpiece support unit that is disposed on the base, and rotatably supports a gear to be machined; and a control unit that controls driving of the tool support unit and the workpiece support unit, the first tool and the second tool are immovably fixed at an interval in an axial direction of each of the first tool and the second tool; each of the first and second tools machines while meshing with the gear to be machined, the workpiece support unit is relatively movable with respect to the tool support unit in a first direction along an axial direction of the gear to be machined, the workpiece support unit is relatively movable with respect to the gear to be machined in such a second direction as to approach and separate from the first and second tools, the tool support unit is rotatable around a vertical axis extending vertically on the base, and the control unit sets one of the first tool and the second tool as a tool for machining that machines the gear to be machined, and machines the gear to be machined after moving the tool for machining to such a position that the tool for machining meshes with the gear to be machined.

In the gear machining device, the control unit can determine a movement distance for relatively moving the workpiece support unit in the first direction such that the tool for machining faces the gear to be machined, determine a movement distance for relatively moving the workpiece support unit in the second direction such that the tool for machining and the gear to be machined mesh with each other, and determine a rotation angle for relatively rotating the tool support unit around the vertical axis such that an axis of the tool for machining and an axis of the gear to be machined are parallel.

In the gear machining device, the control unit assumes that a virtual tool is disposed at a center position in an axial direction between the first tool and the second tool in the housing, and defines meshing between the virtual tool and the gear to be machined as initial setting, and the movement distance in the first direction, the movement distance in the second direction, and the rotation angle can be determined based on the initial setting.

In the gear machining device, the control unit can calculate the movement distance in the first direction, the movement distance in the second direction, and the rotation angle every time at least one machining process is completed.

A gear machining method according to the present invention is a gear machining method performed by the gear machining device described above, and includes the steps of: setting at least one of the first tool and the second tool as the tool for machining that machines the gear to be machined; and machining the gear to be machined after moving the tool for machining to such a position that the tool for machining meshes with the gear to be machined.

A gear machining program according to the present invention is a gear machining program executed by a computer of the gear machining device described above, and causes the computer to execute the steps of: setting at least one of the first tool and the second tool as the tool for machining that machines the gear to be machined; and machining the gear to be machined after moving the tool for machining to such a position that the tool for machining meshes with the gear to be machined.

### Advantageous Effects of Invention

A gear machining device according to the present invention has a simple configuration which does not require any mechanical sliding device and can perform machining using a plurality of tools.

### BRIEF DESCRIPTION OF DRAWINGS

FIG. 1 is a front view illustrating an embodiment of a gear machining device according to the present invention.

FIG. 2 is a plan view of the gear machining device of FIG. 1.

FIG. 3 is a side view of the gear machining device of FIG. 1.

FIG. 4 is a sectional view taken along a line A-A in FIG. 1.

FIG. 5 is a sectional view taken along a line B-B in FIG. 3.

FIG. 6 is a sectional view taken along a line C-C in FIG. 4.

FIG. 7 is a sectional view taken along a line D-D in FIG. 4.

FIG. 8 is an operational diagram from FIG. 6.

FIG. 9 is a sectional view of a housing.

FIG. 10 is a block diagram of a control unit.

FIG. 11A is a projection view of a spacer and a first tool viewed from the Y direction, and FIG. 11B is a projection view of the spacer and the first tool viewed from the X direction.

FIG. 12A is a projection view of the spacer and the first tool viewed from the Y direction, FIG. 12B is a projection view of the first tool and the workpiece viewed from the X direction, and FIG. 12C to FIG. 12E are each a projection views of the first tool and the workpiece viewed from the Z direction.

### DESCRIPTION OF EMBODIMENTS

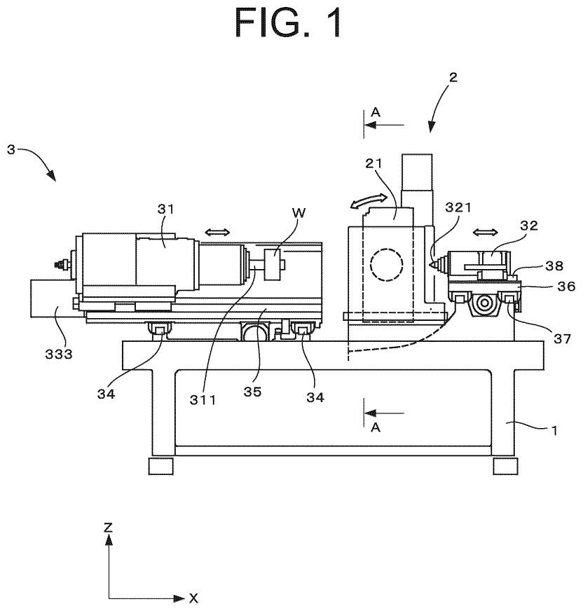

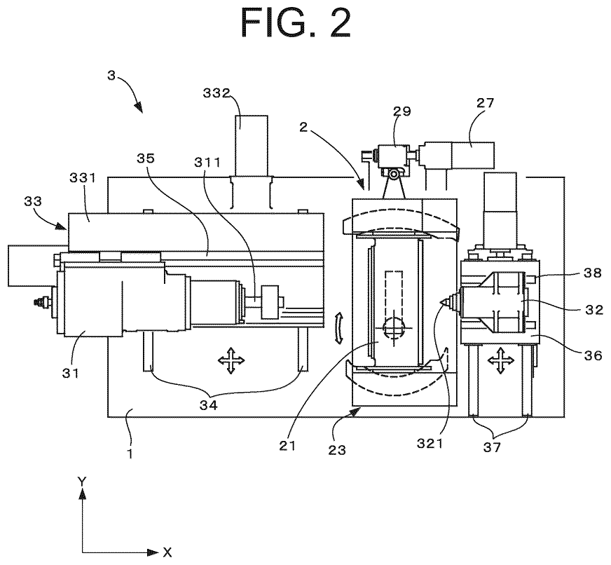

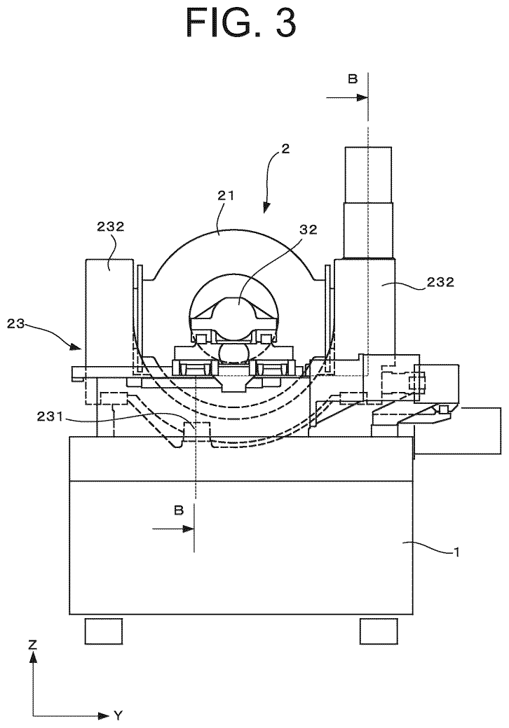

Hereinafter, an embodiment of a gear machining device according to the present invention will be described with reference to the drawings. FIG. 1, FIG. 2, and FIG. 3 are a front view, a plan view, and a side view of the gear machining device according to this embodiment, respectively. In the following description, the left and right of FIG. 1 will be referred to as the X-axis direction, the top and bottom of FIG. 1 will be referred to as the Z-axis, and the top and bottom of FIG. 2 will be referred to as the Y-axis direction, and the description will be made based on these.

### <1. Summary of Gear Machining Device (Gear-Honing Machine)>

The gear machining device (gear-honing machine) according to this embodiment illustrated in FIG. 1 to FIG. 3 is a device for finishing a tooth surface of a workpiece that is a gear to be machined using a horning ring and includes a tool support unit 2 and a workpiece support unit 3 disposed on a base 1. The tool support unit 2 has a housing 21 which has a main part formed into an annular shape, and rotatably holds an internal gear (circular)-shaped tool (horning ring), and the rotation axis direction is oriented approximately in the X-axis direction, and the tool can be meshed with a workpiece W having an external gear shape as a gear to be machined. The workpiece support unit 3 is composed of a headstock 31 and a tailstock 32, between which the workpiece W is held, and the headstock 31 and the tailstock 32 are disposed on both sides of the base 1 along the X-axis direction, with the tool support unit 2 therebetween. This gear machining device is also provided with a control unit that controls various driving of the gear machining device, such as the tool support unit 2 and the workpiece support unit 3. These configurations will be hereinafter described in detail.

### <1-1. Workpiece Support Unit>

Now, the workpiece support unit 3 will be described. As illustrated in FIG. 1 and FIG. 2, the headstock 31 and the tailstock 32 that constitute the workpiece support unit 3 freely approach and separate from each other in the X-axis direction, and when the headstock and the tailstock approach each other, the headstock and the tailstock hold the workpiece W therebetween in a rotatable manner. The headstock 31 is disposed on a support block 33 disposed on the base 1, and this support block 33 is movable on rails 34 disposed in the Y-axis direction. Movement in the Y-axis direction is achieved by screwing a ball screw (not illustrated) into a nut (not illustrated) connected to the support block 33 and driving this ball screw by a motor 332 disposed on the base 1.

On a rail support surface 331 where the headstock 31 is disposed, a rail 35 is disposed in the X-axis direction, and the headstock 31 can be moved in the X-axis direction along this rail 35. As illustrated in FIG. 1, the headstock 31 is moved by a motor 333 provided in the support block 33. A shaft member 311 that protrudes in the X direction and supports the workpiece W is rotatably provided at a tip of the headstock 31 and is rotated by a built-in motor (not illustrated).

The tailstock 32 is configured in a similar manner, and is disposed on a table 36, which can be moved in the Y-axis direction on the base 1 via rails 37. Movement of the table 36 is accomplished by a motor (not illustrated), a ball screw (not illustrated), and a nut (not illustrated) disposed on the base 1, as illustrated in FIG. 2. The tailstock 32 itself can also move on the table 36 in the X-axis direction via rails 38 disposed on table 36.

In addition, a shaft member 321 that supports the workpiece W is rotatably provided at a tip of the tailstock 32, and the W is held between the shaft member 321 and the shaft member 311 of the headstock 31.

The headstock 31 and the tailstock 32 are further controlled to move integrally in the Y-axis direction, and both move in the Y-axis direction in a state in which the headstock and the tailstock hold the workpiece W therebetween, and the workpiece W can be caused to approach the tool of the tool support unit 2 and meshed, and then separated to release the mesh.

### <1-2. Tool Support Unit>

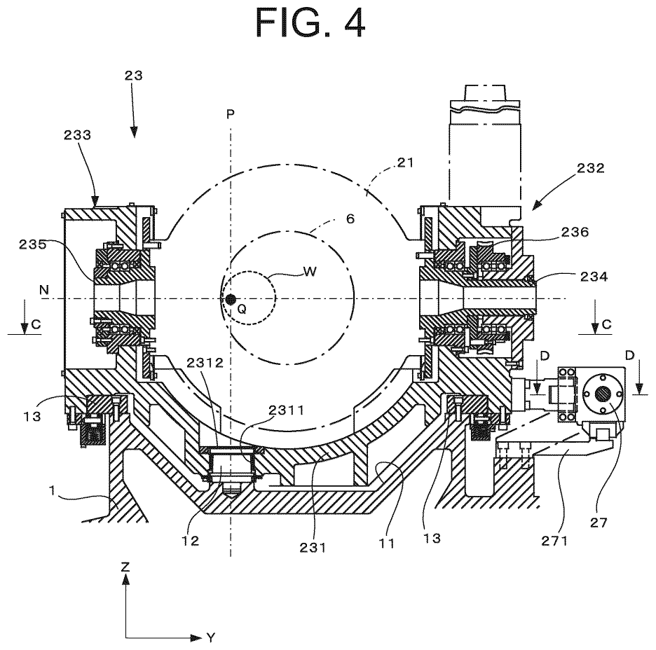

Regarding the tool support unit, FIG. 4 will be described in detail. FIG. 4 is a sectional view taken along a line A-A of FIG. 1. The housing 21 of the tool support unit 2 is configured to form a desired intersection angle in order to machine the tooth surface of the workpiece W and be rotatable around the Y-axis and the Z-axis in order to perform crowning. Therefore, the tool support unit 2 is disposed on the base 1 and includes a supporting body 23 that supports the housing 21 described above. As illustrated in FIG. 4, this supporting body 23 has a base part 231 that can rotate around the Z-axis on the base 1, and support columns 232 and 233 that extend upward from both ends of this base part 231. In the case of this embodiment, the supporting body 23 is formed into a U-shape as a whole. Herein, the support column disposed on the right side of FIG. 4 is referred to as a first support column 232, and the support column disposed on the left side is referred to as a second support column 233.

In the housing 21, a first shaft member 234 (right side in FIG. 4) and a second shaft member 235 (left side in FIG. 4) that protrude toward the respective opposite sides in the Y-axis direction radially outward are mounted and are rotatably supported by the support columns 232 and 233, respectively. As a result, the housing 21 which is disposed between both the support columns 232 and 233 can rotate around the Y axis with both the shaft members 234 and 235 as the center.

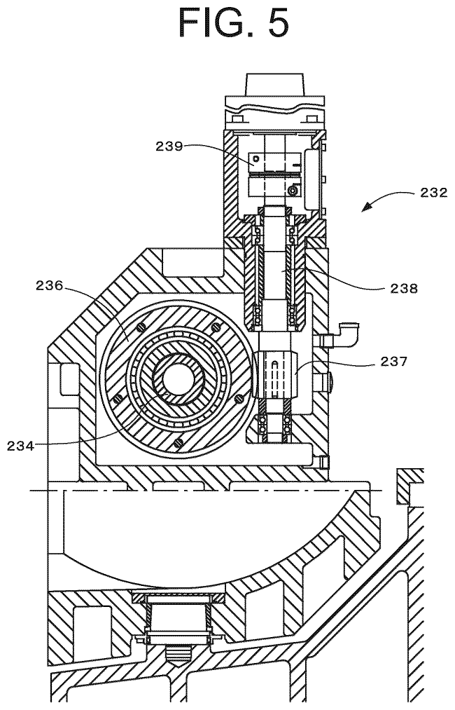

Now, a drive mechanism that drives the rotation of the housing 21 around the Y axis will be described with reference to FIG. 5. FIG. 5 is a sectional view taken along a line B-B of FIG. 3. As illustrated in FIG. 4, a worm wheel 236 is attached to an end of the first shaft member 234. Additionally, as illustrated in FIG. 5, a cylindrical worm 237 that meshes with the worm wheel 236 is provided inside the first support column 232. This cylindrical worm 237 is attached to a rotating shaft 238 that extends in the vertical direction, and this rotating shaft 238 is rotationally driven by a motor 239. Therefore, when the motor 239 is driven, the cylindrical worm 237 rotates, and accordingly the worm wheel 236 rotates together with the first shaft member 234. Consequently, the housing 21 rotates around the Y axis.

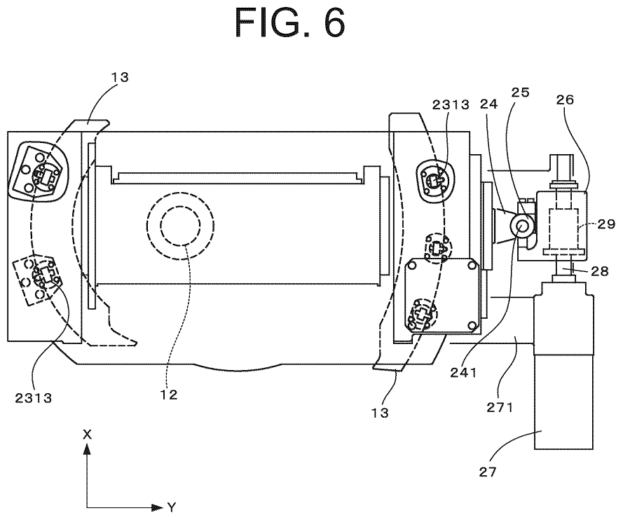

Next, a rotation mechanism of the housing 21 around the Z-axis will be described with reference to FIG. 6. FIG. 6 is a sectional view taken along a line C-C of FIG. 4. As illustrated in FIG. 4, the supporting body 23 supports the housing 21, and the base part 231 of the supporting body 23 is formed in an arc shape to follow the outline of a lower part of the housing 21. Correspondingly, at a location where the supporting body 23 is disposed in the base 1, a recess 11 for allowing the supporting body 23 to be disposed is formed. A columnar shaft member 12 that protrudes upward is attached to this recess 11, and this shaft member 12 is rotatably fitted into a support hole 2311 formed on a lower surface of the base part 231 of the supporting body 23. Furthermore, an upper surface of a through hole 2311 is closed by a cover member 2312.

The shaft member 12 is provided at a position offset from the center of the housing 21 and is provided almost directly below a position Q where a tool 6 and the workpiece W mesh with each other. Therefore, the housing 21 is designed to rotate around a vertical axis P that passes through a position where the tool 6 and the workpiece W mesh. Additionally, as illustrated in FIG. 4 and FIG. 6, arc-shaped sliding plates 13 centered on the shaft member 12 are disposed at both respective ends in the Y-axis direction of the recess 11 of the base 1, and both ends of the base part 231 of the supporting body 23 are placed on the sliding plates 13. A plurality of rollers 2313 are attached to lower surfaces of both ends of the base part 231 and are designed to roll on the sliding plates 13. With such sliding plates 13 and rollers 2313, the supporting body 23 can smoothly rotate on the base 1 around the vertical axis P.

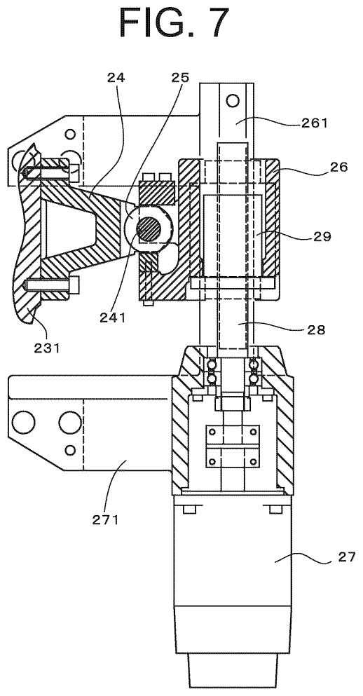

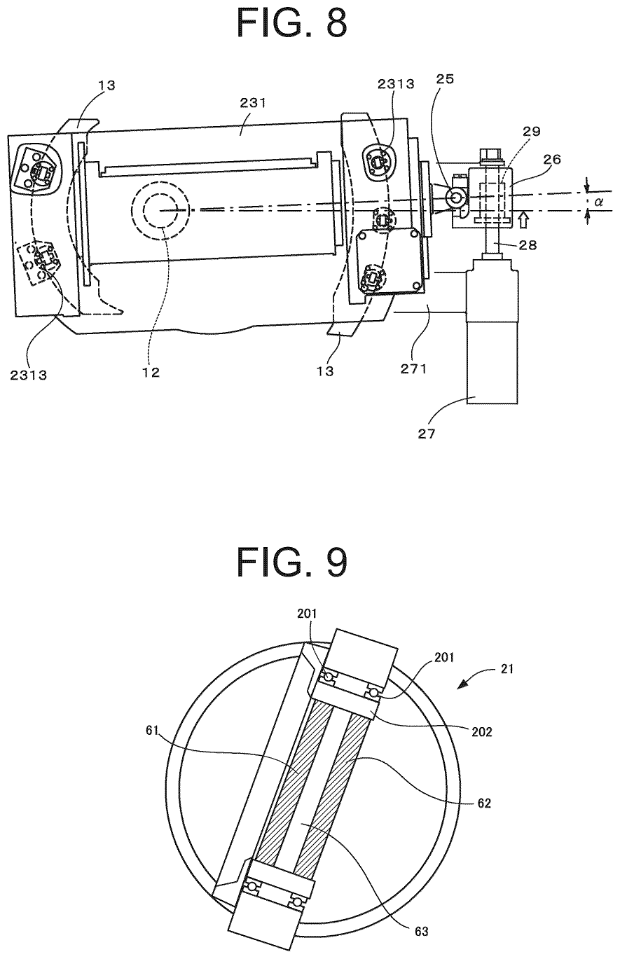

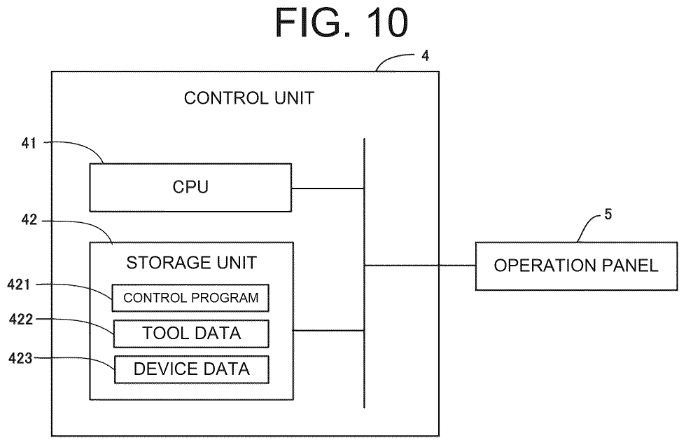

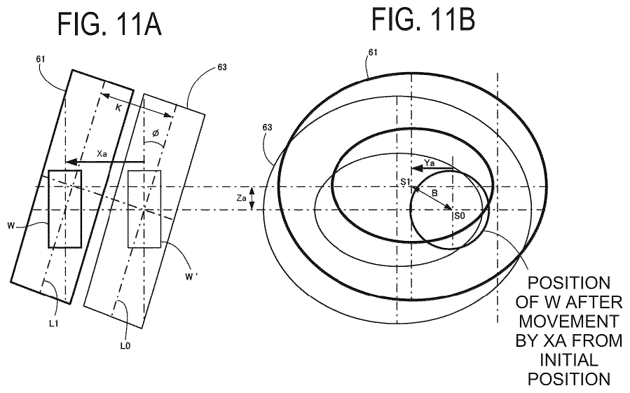

Next, the drive mechanism (supporting body drive mechanism) (same as above) that drives rotation of the supporting body 23 around a P axis will be described with reference to FIG. 7 and FIG. 8. FIG. 7 is a sectional view taken along a line D-D of FIG. 4, and FIG. 8 is an operational diagram from FIG. 6. As illustrated in FIG. 6, a roller 25 is rotatably attached to an end of the base part 231 of the supporting body 23 (left side in FIG. 7) via a bracket 24. This roller 25 is rotatably fitted into a vertically extending shaft member 241 attached to the bracket 24. This roller 25 is held in the X-axis direction by a holding member 26 that has a pair of arms. This holding member 26 can move on a rail 261 extending in the X direction.

Additionally, a motor 27 is attached to an end of base 1 (on the right side of FIG. 6) via a bracket 271, and this motor 27 rotates a ball screw 28 that extends in the X-axis direction. The ball screw 28 is screwed into a nut 29, and this nut 29 is fixed to the holding member 26 described above.

With this configuration, when the motor 27 is driven, the ball screw 28 rotates, and with this rotation, the nut 29 moves in the X direction together with the holding member 26, as illustrated in FIG. 8. The holding member 26 holds the holding roller 25, and therefore the roller 25 also moves in the X direction. At this time, the roller 25 is fixed to the supporting body 23 via the bracket 24, and therefore the movement of the roller 25 causes the supporting body 23 to swing around the shaft member 12 by an angle α. Since the roller 25 is only held between the arms of the holding member 26 and is not completely fixed, when linear motion of the nut 29 is converted into swinging motion, the roller 25 can move slightly in the Y-axis direction between the arms of the holding member 26, and therefore the supporting body 23 performs smooth swinging motion.

Now, the housing will be described with reference to FIG. 9. FIG. 9 is a sectional view of the housing. As illustrated in FIG. 9, the main part of the housing 21 is formed into an annular shape, and a pair of bearings 201 are disposed on an inner circumferential surface of the housing. In inner rings of the bearings 201, an internal gear-shaped first tool 61 and second tool 62 and an annular spacer 63 are disposed side by side along the rotation axis direction via an annular bracket 202. Therefore, the first tool 61, the second tool 62, and the spacer 63 are rotatable around the axial direction of the housing 21 via the bearings 201. The spacer 63 is fixed to the vicinity of the axial center of the housing 21. The first tool 61 and the second tool 62 are detachably disposed with the spacer 63 therebetween in the housing 21.

Although not illustrated, in this embodiment, the tools 61 and 62 and the spacer 63 are rotated by an electric motor built into the housing 21 via the bracket 202. Therefore, an annular rotor part is connected to an outer circumferential surface of the bracket 202. Additionally, a stator part is fixed to an inner wall surface of the housing 21 at a position facing a rotor part. These rotor part and stator part are designed to rotate the tools 61 and 62 and the spacer 63 inside the housing 21 via the bracket 202.

Furthermore, rotational positions of the tools 61 and 62 can be detected by an annular scale with a magnetic memory fixed to the bracket 202 and a magnetic encoder fixed to the housing 21.

### <1-3. Control Unit>

Next, a control unit 4 will be described with reference to FIG. 9. As illustrated in FIG. 9, the control unit 4 can be composed of a PLC or a general-purpose computer with a CPU 41, a RAM (not illustrated), and a storage unit 42, and controls various driving of the gear machining device.

As described later, the storage unit 42 stores a control program 421 for machining the workpiece W using at least one of the two tools 61 and 62, tool data 422 containing specification information such as the shapes of the tools, and device data 423 related to the devices such as the tool support unit 2 and the workpiece support unit 3. In addition, the storage unit 42 of the control unit 4 stores various data for machining the workpiece W and driving the gear machining device. In addition, an operation panel 5, which has an input means such as a touch panel and a keyboard, and a display means such as a display, is connected to the control unit 4, and an operator can operate the gear machining device through this operation panel 5.

### <2. Control for Meshing Between Workpiece and Tool>

Now, control for meshing of the workpiece W and the tools 61 and 62 by the control unit will be described. The gear machining device according to this embodiment is provided with the two tools 61 and 62, and therefore at least one of the tools 61 and 62 is selected for a specific workpiece W to be machined. The selected tool is sometimes referred to as a tool for machining. Hereinafter, an example in which the first tool 61 on the left side illustrated in FIG. 9 is selected as the tool for machining, and the workpiece W is machined using this tool will be described.

In a general gear machining device that has a single tool, the single tool is disposed at the center of a housing 21 in the axial direction, and therefore various setting for machining is set such that the tool disposed in the center and a workpiece W mesh with each other. In other words, the positional relationship between the tool having an intersection angle and the workpiece W in the X direction, in the Y direction, and around the Z-axis is set. Hereinafter, setting related to this positional relationship will be referred to as initial setting.

In contrast, in this embodiment, the two tools 61 and 62 are disposed with the spacer 63 disposed at the center of the housing 21 therebetween, and therefore in a case where either one of the tools 61 and 62 are selected, it is necessary to adjust the three positional relationships between the selected tool for machining and the workpiece in the X direction, in the Y direction, and around the Z-axis.

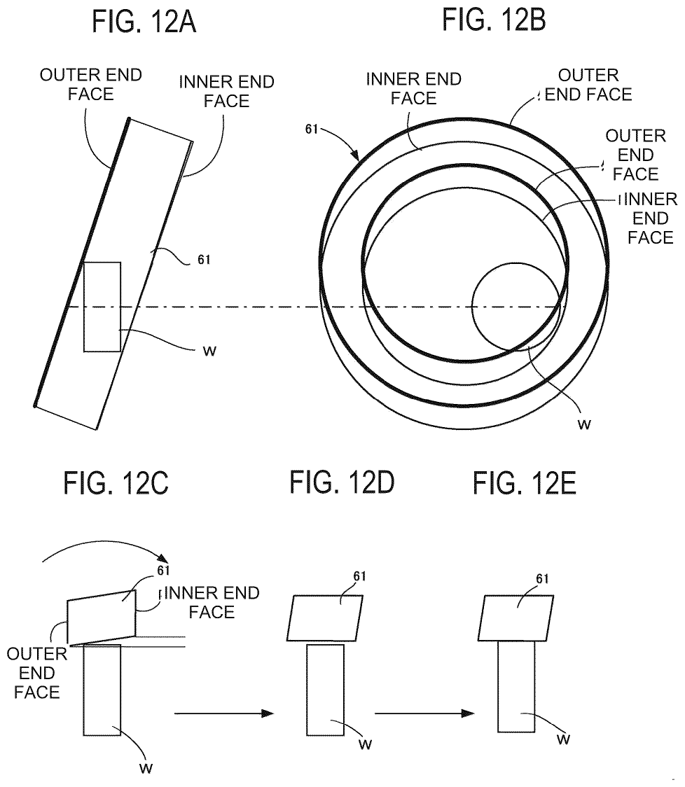

This adjustment will be described below with reference to FIG. 11 and FIG. 12. FIG. 11A is a projection view of the spacer and the first tool viewed from the Y direction, FIG. 11B is a projection view of the spacer and the first tool viewed from the X direction, and FIG. 12A is a projection view of the spacer and the first tool viewed from the Y direction, FIG. 12B is a projection view of the first tool and the workpiece viewed from the X direction, and FIG. 12C to FIG. 12E are projection views viewed of the first tool and the workpiece viewed from the Z direction.

As described above, the tool in a general gear machining device is disposed at the center in the axial direction of the housing 21, but in this embodiment, the spacer 63 is disposed at the center of the housing 21. Therefore, assuming that the tool is disposed at the position of this spacer 63, the initial setting described above is made. Therefore, hereinafter, how to make adjustment from the initial setting when the first tool 61 is set as the tool for machining will be described. The following adjustment is executed by the control program described above.

Now, adjustment in the X direction will be described. As illustrated in the right side of FIG. 11A, in the initial setting, the workpiece W is set to mesh at such a position as to face the spacer 63 having an intersection angle. As illustrated on the left side of FIG. 11A, it is necessary to position the workpiece at such a position as to face the first tool 61. In other words, in order to cause a workpiece W′, which is at such a virtual position as to face the spacer 63 as the initial setting, to face the first tool 61, the workpiece W is moved relatively in the X direction. At this time, where a distance between a center line L0 in the axis (width) direction of the spacer 63 and a center line L1 in the axis (width) direction of the first tool 61 is K, and the intersection angle is φ, a movement amount Xa in the X direction is calculated using the following Expression (1).

$$Xa = K / cos φ \qquad ( 1 )$$

FIG. 11B illustrates a state on the left side of FIG. 11A as viewed from the X direction. The workpiece W is moved by the movement amount Xa from the initial position. FIG. 11B is a projection view of the first tool 61 and the spacer 63 as viewed from the X direction. When the workpiece W is at a position illustrated in FIG. 11B, the meshing amount between the first tool 61 and the workpiece W is too large, and therefore it is necessary to reduce a cutting amount of the workpiece W by Ya.

First, the axial center of the first tool 61 is located higher than the axial center of the spacer 63 by Za. Za is calculated using the following Expression (2).

$$Z a = K / sin φ \qquad ( 2 )$$

Now, as illustrated in FIG. 11B, when a distance between the axial center S0 of the workpiece W and the axial center S1 of the first tool 61 after moving in the X direction in FIG. 11A is B, the moving distance Ya in the Y direction has the relationship of the following Expression (3), and therefore Ya is calculated from Expression (3). Then, when the workpiece W is separated from the first tool 61 by Ya, the cutting amount of the workpiece W with respect to the first tool 61 becomes appropriate.

$$Ya 2 = B 2 - Za 2 \qquad ( 3 )$$

Next, while referring to FIG. 12, the positional relationship between the first tool 61 and the workpiece W will be described. The housing 21 rotates around the Z-axis, and therefore as illustrated in FIG. 12A to FIG. 12C, an end face on the spacer 63 side in the first tool 61 (hereinafter referred to as an inner end face), and an end face opposite to the inner end face (hereinafter referred to as an outer end face) are not parallel to the X direction but intersect with each other. Therefore, teeth of the workpiece W and teeth of the first tool 61 are not in parallel contact. Therefore, when machining is performed in this state, an amount of removal in the tooth width direction is not constant. On the other hand, as illustrated in FIG. 12D, the housing 21 is rotated around the Z-axis such that the teeth of the workpiece W and the teeth of the first tool 61 are made parallel. Due to this rotation, the workpiece W and the first tool 61 are separated from each other, and therefore the distance in the Y direction between the workpiece W and the first tool 61 are adjusted again as illustrated in FIG. 12E.

Thus, the adjustment of the meshing position when machining the workpiece W with the first tool 61 is completed. On the other hand, when the workpiece W is machined with the second tool 62, it is sufficient to move the workpiece W relative to the second tool 62 to the side opposite to the above.

The adjustment of the meshing position as described above is performed each time a workpiece is machined. The following Table 1 is a table indicating an example of adjusting the meshing positions during the first machining to the third machining. Thus, the control unit 4 adjusts the meshing position before machining each time, but this adjustment can be changed as appropriate, for example, every second or third time. The data indicated in Table 1 is stored in the storage unit 42 as the tool data 422 and the device data 423.

TABLE 1

| Common | Grindstone Shift Amount (X) | 34.750 | | | |
|---|---|---|---|---|---|
| | Machining Center Position (X) | −566.500 | | | |
| | B-axis Rotation Center - B-axis Driving Part Distance | 960.000 | | | |
| | Number of Dress | 0 | 1 | 2 | 3 |
| | Pre-correction Intersection Angle q° (Y) | 11.000 | 11.054 | 11.108 | 11.161 |
| | Ya | 6.631 | 6.663 | 6.695 | 6.727 |
| | Grindstone Left End Ya | 9.540 | 9.587 | 9.633 | 9.679 |
| | Grindstone Right End Ya | 3.721 | 3.739 | 3.757 | 3.775 |
| Workpiece | Pre-correction Distance between Workpiece Axes (Z) | 108.380 | 108.480 | 108.580 | 108.680 |
| Machining | Corrected Intersection Angle (Y) | 10.974 | 11.028 | 11.081 | 11.135 |
| | Ya | 6.615 | 6.647 | 6.679 | 6.711 |
| | Grindstone Left End Ya | 9.518 | 9.564 | 9.610 | 9.656 |
| | Grindstone Right End Ya | 3.712 | 3.730 | 3.748 | 3.766 |
| | Intersection Angle Change X-axis Correction Amount | 35.397 | 35.404 | 35.410 | 35.417 |
| | Intersection Angle Change Z-axis Correction Amount | 0.202 | 0.204 | 0.206 | 0.207 |
| | Grindstone End Z Coordinate Difference | −0.355 | −0.358 | −0.361 | −0.365 |
| | B-axis Rotation Angle ° | −0.667 | −0.673 | −0.679 | −0.685 |
| | B-axis Movement Amount (B) | −11.179 | −11.277 | −11.375 | −11.473 |
| | B-axis Rotation X-axis Correction Amount | −0.005 | −0.005 | −0.005 | −0.005 |
| | B-axis Rotation Z-axis Correction Amount | −0.405 | −0.408 | −0.412 | −0.415 |
| | Meshing Position Angle | 356.501 | 356.487 | 356.473 | 356.460 |
| | B-axis Rotation Angle Y-axis Influence Conversion Angle | 0.026 | 0.026 | 0.027 | 0.027 |
| | Corrected Machining Start Position (Z) | −108.580 | −108.682 | −108.784 | −108.885 |
| | Corrected Machining Center Coordinate (X) | −531.107 | −531.101 | −531.095 | −531.088 |
| | Corrected Machining Completion Position (Z) | −108.650 | −108.752 | −108.854 | −108.955 |

Table 1 indicates final coordinates of each axis when the Y-axis, which is a rotation axis of the tool support unit 2, is changed each time dress machining is performed. In a case where the Y-axis position (intersection angle Θ (Y) before correction) changes each time dress machining is performed, and the number of teeth differs from that of the workpiece, the Y-axis position (intersection angle (Y) after correction) during workpiece machining is obtained. For that value, each axis is corrected by an offset amount of the Y-axis rotation center and the machining position (corrected machining start position (Z), corrected machining center coordinate (X)) is set. 0→3 in the table is the position of each axis when corrected during workpiece machining and does not change during machining at this position until dressing is performed.

When machining, for example, information indicated in the following Table 2 is entered using the operation panel 5 before machining.

TABLE 2

| | |
|---|---|
| Grindstone Shift Amount (X) | 34.750 |
| Machining Center Position (X) | −566.500 |
| B-axis Rotation Center - B-axis Driving Part Distance | 960.000 |

Workpiece Data Input Screen

| | |
|---|---|
| Link Program No. | 0 |
| Workpiece Attitude | 0: Standard [symbol] |
| Module | 0.000 |
| Normal Pressure Angle | 0.000° |
| Number of Workpiece Teeth | 0 |
| Workpiece Torsion Angle (LH: −, RH: +) | 0.000° |
| Tooth Tip Outer Diameter | 0.000 mm |
| Dedendum Diameter | 0.000 mm |
| Honing Diameter | 0.000 mm |
| Tooth Width | 0.000 mm |

Furthermore, when the movement distance described above is calculated once at the start of machining, movement can be performed by using a result calculated once for the next machining.

### <3. Characteristics>

As described above, according to this embodiment, after the two tools 61 and 62 are fixed to the housing 21, the meshing position of one of the tools 61 and 62 and the workpiece W can be controlled by the control unit 4. Therefore, there is no need for a mechanical mechanism for moving the tool as in a conventional example, and the configuration of the device can be simplified. Consequently, it is possible to machine tooth surfaces having a plurality of gears such as a two-stage gear, without tool exchange. Additionally, in a case where the same tools are provided, machining can be performed for a long time without stopping the machine to exchange worn tools.

### <4. Modification>

Although one embodiment of the present invention is described above, the present invention is not limited to this, and various changes can be made without departing from the spirit thereof.

(1) For example, in the above embodiment, machining is performed by fixing the tool support unit 2 and causing the workpiece support unit 3 to approach the tool support unit 2. However, on the contrary, the workpiece support unit 3 may be fixed, and the tool support unit 2 may be moved. In addition, in the workpiece support unit 3, the workpiece W is held between the headstock 31 and the tailstock 32, but the workpiece W may be supported only by the headstock 31.

(2) In the above embodiment, the built-in motor is disposed inside the housing of the tool support unit 2, but the motor is attached to the outside of the tool support unit 2 and the tools 61 and 62 in the tool support unit 2 can also be rotated via a transmission mechanism such as a gear.

(3) In the above embodiment, assuming that a virtual tool is disposed at the position where the spacer 63 is disposed, the meshing position of the first tool 61 or the second tool 62 and the workpiece W is adjusted based on the meshing position of this virtual tool and the workpiece W. However, the present invention is not limited to this. In other words, the virtual tool position is not limited to the position where the spacer 63 is disposed but may be at other position.

(4) Each tool can continue to be used during a series of machining, or, for example, two machining processes can be performed using the first tool 61 and the second tool 62.

### REFERENCE SIGNS LIST

2 tool support unit
21 housing
23 supporting body
25 rotating member
3 workpiece support unit
4 control unit
61 first tool
62 second tool

1. A gear machining device comprising:
a base;
a tool support unit that is disposed on the base, has internal gear-shaped rotatable first and second tools, and immovably fixes the first tool and the second tool at a predetermined interval in a rotation axis direction of each of the first tool and the second tool;
a workpiece support unit that is disposed on the base, and rotatably supports a gear to be machined; and
a control unit that controls driving of the tool support unit and the workpiece support unit, wherein
each of the first and second tools machines while meshing with the gear to be machined,
the workpiece support unit is relatively movable with respect to the tool support unit in a first direction along an axial direction of the gear to be machined,
the workpiece support unit is relatively movable with respect to the gear to be machined in such a second direction as to approach and separate from the first and second tools,
the tool support unit is rotatable around a vertical axis extending vertically on the base, and
the control unit
sets one of the first tool and the second tool as a tool for machining that machines the gear to be machined, and
machines the gear to be machined after moving the tool for machining to such a position that the tool for machining meshes with the gear to be machined.

2. The gear machining device according to claim 1, wherein
the control unit determines a movement distance for relatively moving the workpiece support unit in the first direction such that the tool for machining faces the gear to be machined, determines a movement distance for relatively moving the workpiece support unit in the second direction such that the tool for machining and the gear to be machined mesh with each other, and determines a rotation angle for relatively rotating the tool support unit around the vertical axis such that an axis of the tool for machining and an axis of the gear to be machined are parallel.

3. The gear machining device according to claim 2, wherein
the control unit assumes that a virtual tool is disposed at a center position in an axial direction between the first tool and the second tool in the housing and defines meshing between the virtual tool and the gear to be machined as initial setting, and the movement distance in the first direction, the movement distance in the second direction, and the rotation angle are determined based on the initial setting.

4. The gear machining device according to claim 2, wherein
the control unit calculates the movement distance in the first direction, the movement distance in the second direction, and the rotation angle every time at least one machining process is completed.

5. A gear machining method performed by the gear machining device according to claim 1, comprising the steps of:
setting at least one of the first tool and the second tool as the tool for machining that machines the gear to be machined; and
machining the gear to be machined after moving the tool for machining to such a position that the tool for machining meshes with the gear to be machined.

6. A gear machining program executed by a computer provided in the gear machining device according to claim 1, comprising the steps of:
setting at least one of the first tool and the second tool as the tool for machining that machines the gear to be machined; and
machining the gear to be machined after moving the tool for machining to such a position that the tool for machining meshes with the gear to be machined.
